(19) United States
(12) Patent Application Publication
(10) Pub. No.: US 2015/0215374 A1
(43) Pub. Date: Jul. 30, 2015

(54) DELIVERING AN UPDATE FOR A WEB APPLICATION

(71) Applicant: Google Inc., Mountain View, CA (US)

(72) Inventors: Robert Hundt, Piedmont, CA (US); Mark Heffernan, Mountain View, CA (US); Ian Tinkham McCabe Flanigan, Zurich (CH)

(73) Assignee: Google Inc., Mountain View, CA (US)

(21) Appl. No.: 13/892,158

(22) Filed: May 10, 2013

Related U.S. Application Data
(60) Provisional application No. 61/780,679, filed on Mar. 13, 2013.

(51) Int. Cl. H04L 29/08

(52) U.S. Cl. CPC H04L 67/10

(57) ABSTRACT

Systems and methods for delivering an update for a web application are provided. In some aspects, a request to access a web application is received from a client computing device. A last version of the web application provided to a computing device having an identifier associated with the client computing device is determined based on data stored locally at a server. A delta file is provided to the client computing device in response to the request to access the web application. The delta file includes indicia of a difference between a current version of the web application stored at the server and the last version of the web application provided to the computing device having the identifier associated with the client computing device.

### CROSS REFERENCE TO RELATED APPLICATIONS

This application claims priority under 35 U.S. C. §119(e) and the benefit of U.S. Provisional Application No. 61/780,679, filed Mar. 13, 2013, and entitled, “DELIVERING AN UPDATE FOR A WEB APPLICATION,” the entire disclosure of which are incorporated herein by reference.

### BACKGROUND

The subject technology generally relates web interfaces and, in particular, relates delivering update(s) for web application(s) to client computing device(s).

Web applications (e.g., electronic messaging applications, social networking applications, newspaper applications, etc.) are typically provided via web pages that are accessible via a web browser or another application executing on a client computing device. However, delivering large web applications to client computing device(s) may take much network download time or network resources.

### SUMMARY

In some aspects, the disclosed subject matter relates to a computer-implemented method for providing a web application. The method includes receiving, from a client computing device, a request to access a web application. The method includes determining, based on data stored locally at a server, a last version of the web application provided to a computing device having an identifier associated with the client computing device. The method includes providing, to the client computing device in response to the request to access the web application, a delta file, the delta file including indicia of a difference between a current version of the web application stored at the server and the last version of the web application provided to the computing device having the identifier associated with the client computing device.

In some aspects, the disclosed subject matter relates to a computer-implemented method for loading a web application. The method includes storing, at a client computing device, a last version of a web application previously accessed by the client computing device. The method includes transmitting a request to access the web application. The method includes receiving, in response to the request to access the web application, a delta file, where the delta file includes indicia of a difference between a current version of the web application stored at a server and the last version of the web application stored at the client computing device, and where the delta file includes one or more markers indicating one or more locations of one or more changes to the last version of the web application. The method includes compiling a portion of the last version of the web application, where the portion of the last version of the web application is configured to be executed in advance of execution of code at the one or more markers. The method includes recreating the current version of the web application at the client computing device based on the last version of the web application and the delta file.

In some aspects, the disclosed subject matter relates to a system for providing a web application. The system includes one or more processors and a memory. The memory includes instructions. The instructions include code for receiving, from a client computing device, a request to access a web application. The instructions include code for determining, based on data stored locally in the memory and without providing a query to the client computing device, a last version of the web application provided to a computing device having an identifier associated with the client computing device. The instructions include code for providing, to the client computing device in response to the request to access the web application, a delta file, the delta file including indicia of a difference between a current version of the web application stored locally in the memory and the last version of the web application provided to the computing device having the identifier associated with the client computing device.

In some aspects, the disclosed subject matter relates to a computer-readable medium encoded with executable instructions for loading a web application. The instructions include code for storing, in a local memory of a computer, a last version of a web application previously accessed by the computer. The instructions include code for transmitting a request to access the web application. The instructions include code for receiving, in response to the request to access the web application, a delta file, where the delta file includes indicia of a difference between a current version of the web application stored at a server and the last version of the web application stored at the computer. The instructions include code for compiling a portion of the last version of the web application, where the portion of the last version of the web application includes code that is identical in both the last version of the web application stored at the client computing device and the current version of the web application stored at the server. The instructions include code for recreating the current version of the web application at the computer based on the last version of the web application and the delta file. The instructions include code for compiling and executing the recreated current version of the web application at the computer.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example of a system for delivering an update for a web application.

FIG. 2 illustrates an example of the client computing device of FIG. 1.

FIG. 3 illustrates an example of the server of FIG. 1.

FIGS. 4A-4B illustrates an example process by which a web application may be provided.

FIG. 5 illustrates an example process by which a web application may be loaded.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

As set forth above, web applications are typically provided via a client application, for example, a web browser or a special purpose mobile device application. A client computing device typically stores a latest version of a web application that the client computing device accessed. In some cases, a delta file is provided to the client computing device to update the client computing device to a current version of the web application, as stored at the server. The delta file indicates the difference between the latest version of the web application at the client computing device and the current version of the web application, stored at a server. In such circumstances, multiple queries may need to be transmitted between the client computing device and the server for the server to determine the latest version of the web application stored at the client computing device and to provide the appropriate delta file.

The subject technology provides techniques for providing updates to a web application, which may be provided via a web page.

According to some aspects, a server receives, from a client computing device, a request to access a webpage. For example, a user of the client computing device enters “www.example.com” in a uniform resource locator (URL) input box of a web browser, and a request for a web application associated with www.example.com is transmitted to the server.

The server determines, based on data stored locally at the server, a last version of the web application provided to a computing device having an identifier associated with the client computing device. The identifier can be, for example, a user identifier, an Internet Protocol (IP) address, an identifier of a specific browser executing on a specific client computing device (e.g., a user agent string), or one or more cookies. For example, the server can store, in a local memory or data repository of the server, an indication that a version of a web application has been transmitted to a computing device with a specified identifier. As a result, the server is able to determine the last version of the web application provided to the computing device having the specified identifier without having to query the computing device or without receiving information from the computing device. In other words, the computing device need not notify the server which version of the web application is stored on the computing device.

The server provides, to the client computing device in response to the request to access the web application, a delta file. The delta file includes indicia of a difference between a current version of the web application and the last version of the web application. The delta file also includes marker(s) indicating location(s) of change(s) to the last version of the web application. The delta file can be configured to implement VCDIFF decoding to allow for fast execution and processing at the client computing device. In some aspects, the delta file is embedded into boilerplate hypertext markup language (HTML) or JavaScript code.

In some aspects, the client computing device recreates the current version of the web application locally at the client computing device based on the last version of the web application and the delta file. In some aspects, after providing the delta file, the server also provides, to the client computing device, the current version of the web application. As a result, if the client computing device is unable to recreate the current version of the web application based on the delta file, the client computing device is still able to access the web application using the current version provided by the server.

According to some aspects, a client computing device stores, in a local memory of the client computing device, a last version of a web application previously accessed by the client computing device. The client computing device receives, in response to a request to access the web application, a delta file as specified above.

The client computing device determines a portion of the code of the last (before updating using the delta file) version of the web application that can be compiled while parts of the delta file are being downloaded and applied, without impacting compiling of the parts of the code modified by the delta file. In some aspects, marker(s) are added to the code to indicate the portion of the code of that can be compiled. The portion of the code can include block(s) or line(s) of code to which the delta file has already been applied. In some implementations, the delta decoding involves emitting code from the beginning to the end (e.g., a stream of code). In accordance with these implementations, the first (e.g., beginning) block(s) or line(s) of the code to complete the delta decoding can be compiled while later portions are still being delta decoded or while the delta file is still downloading.

The client computing device recreates the current version of the web application based on the last version of the web application and the delta file. In some aspects, the client computing device accesses the web application via a browser. The browser is implemented in C++ and is configured to execute web application(s) implemented in JavaScript. The code for recreating the current version of the web application based on the last version of the web application and the delta file is written in C++, as such code can involve changing parts of strings, which is accomplished much faster in C++ than in JavaScript. In some aspects, to invoke the C++ code for recreating the current version of the web application, the JavaScript web application invokes the C++ code through an application programming interface (API) exposed by the browser. In some aspects, the browser's C++ code performs the decoding transparently without explicit control by the web application. In alternative implementations, the browser can be implemented in any programming language instead of C++ and the browser can be configured to execute web application(s) implemented in any programming or scripting language instead of JavaScript.

After recreating the current version of the web application, the client computing device can compile or execute the current version of the web application, as now stored at the client computing device.

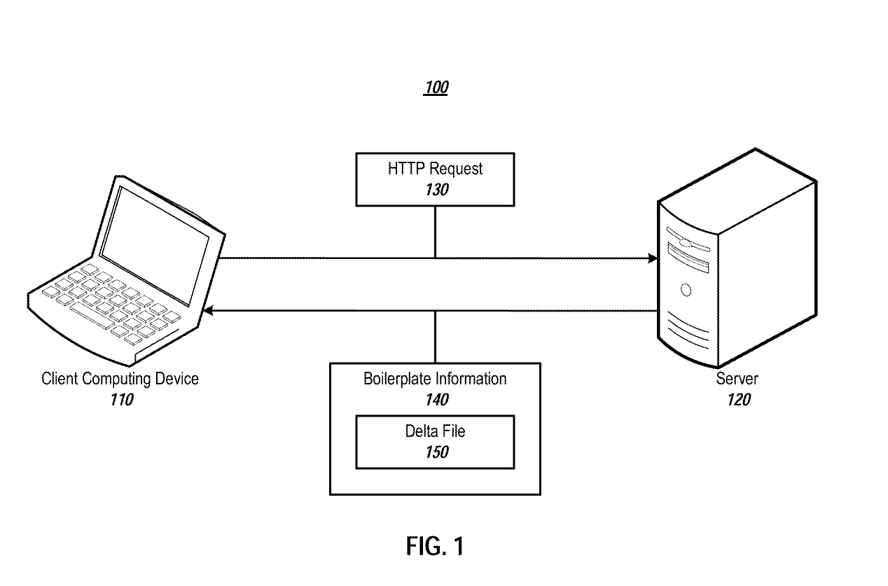

FIG. 1 illustrates an example of a system 100 for delivering an update for a web application.

As shown, the system 100 includes a client computing device 110 and a server 120 communicating via a network, for example, the Internet, a cellular network, a local area network, a wide area network, a virtual private network, etc. The client computing device 110 may be a mobile phone, a personal digital assistant (PDA), a personal digital music player, a tablet computer, a laptop computer, a desktop computer, a television with one or more processors embedded therein or coupled thereto, etc. The server 120 can include a single server or a server farm with multiple servers. While only a single client computing device 110 and server 120 are illustrated, the subject technology may be implemented with multiple client computing devices or multiple servers.

As illustrated in FIG. 1, the client computing device 110 transmits a hypertext transfer protocol (HTTP) request 130 to the server 120. The HTTP request 130 can include a request for a web page that includes a web application, for example, an electronic messaging application, a calendar application, a video application, or a social networking application. The HTTP request 130 can include a uniform resource locator (URL) for the requested web page or the requested web application.

In response to the HTTP request 130, the server 120 provides boilerplate information 140 to the client computing device 110. The boilerplate information 140 includes boilerplate hypertext markup language (HTML) or scripting language (e.g., JavaScript) code. The boilerplate information 140 also includes a delta file 150. The delta file 150 includes indicia of change(s) to the web application that have been made at the server 120 since the web application was last accessed by the client computing device 110. As described in greater detail below, by using the delta file 150, the client computing device 110 can update the version of the web application stored in the local storage of the client computing device 110 to be equivalent to the current version of the web application stored at the server 120.

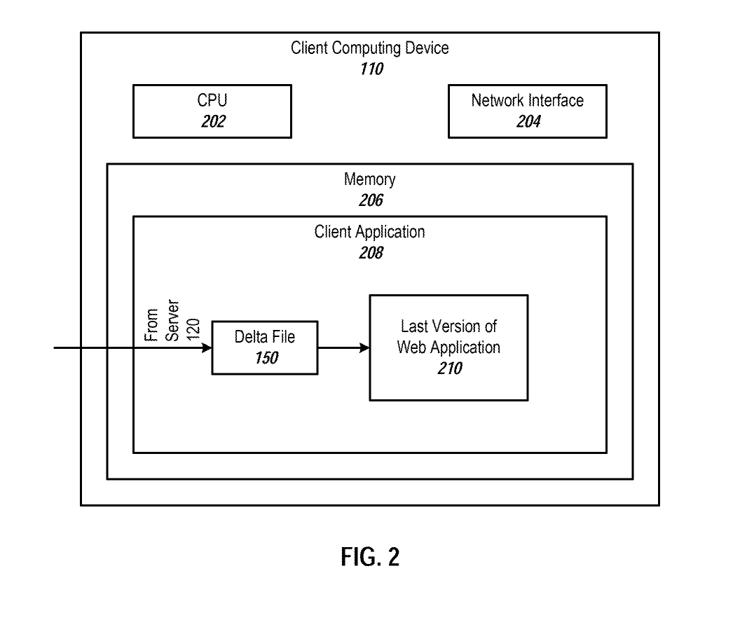

FIG. 2 illustrates an example of the client computing device 110 of FIG. 1.

As shown, the client computing device 110 includes a central processing unit (CPU) 202, a network interface 204, and a memory 206. The CPU 202 may include one or more processors. The CPU 202 is configured to execute computer instructions that are stored in a computer-readable medium, for example, the memory 206. The network interface 204 is configured to allow the client computing device 110 to transmit and receive data in a network, e.g., to communicate with the server 120. The network interface 204 may include one or more network interface cards (NICs). The memory 206 stores data and/or instructions. The memory 206 may be one or more of a cache unit, a storage unit, an internal memory unit, or an external memory unit. As illustrated, the memory 206 includes a client application 208.

The client application 208 can be any application for executing web application(s), e.g., viewing web page(s) executing code associated with the viewed webpage(s). For example, the client application 208 can be a web browser or a mobile phone or tablet computer application for viewing certain Internet-based content (e.g., a mobile phone social networking application). As shown, the client application 208 includes the delta file 150 and a last version of a web application 210.

The last version of the web application 210 includes code (e.g., scripting language code, for example, JavaScript code) for the last version of the web application from the last time the client computing device accessed the web application.

As shown in FIG. 2, the delta file 150 is received, from the server 120 and applied to the last version of the web application 210. The delta file 150 is received in response to a request (e.g., HTTP request 130) to access the web application. The delta file 150 includes indicia of a difference between a current version of the web application stored at the server 120 and the last version of the web application 210. In some aspects, the delta file 150 includes one or more marker(s) indicating location(s) of change(s) to the last version of the web application to be made by the delta file. By applying the delta file 150 to the last version of the web application 210, the last version 150 of the web application 210 may be transformed into the current version of the web application, as stored at the server 120. As a result, the current version of the web application, as stored at the server 120, can be recreated at the client computing device 110.

In some aspects, the last version of the web application 210, as well as the current version of the web application stored at the server 120, are written in a scripting language (e.g., JavaScript) and configured to execute within the client application. The client application 208 is written in a programming language (e.g., C or C++) different from the scripting language. Recreating the current version of the web application at the client computing device 110 can include executing code from the delta file 150, where the code from the delta file 150 is written in the programming language of the client application. To execute the code from the delta file 150, the web application can invoke the code from the delta file 150 via an API exposed by the client application 208. Alternatively, the code from the delta file 150 is executed within the client application 208 without explicit control of the web application. In some examples, the delta file 150 implements VCDIFF decoding to allow for fast execution and processing at the client computing device 110. In yet other alternative implementations, the delta file 150 may include code in the scripting language of the web application and be processed directly by the web application (e.g., combined or merged with the existing code for the last version of the web application 210).

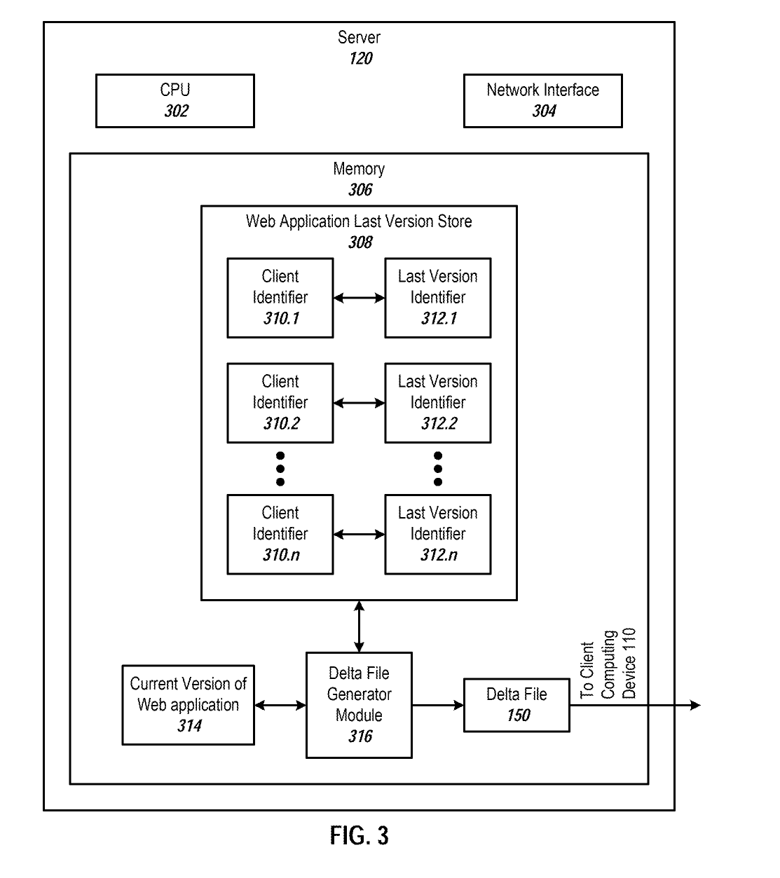

FIG. 3 illustrates an example of the server 120 of FIG. 1.

As shown, the server 120 includes a central processing unit (CPU) 302, a network interface 304, and a memory 306. The CPU 302 may include one or more processors. The CPU 302 is configured to execute computer instructions that are stored in a computer-readable medium, for example, the memory 306. The network interface 304 is configured to allow the server 120 to transmit and receive data in a network, e.g., to communicate with the client computing device 110. The network interface 304 may include one or more network interface cards (NICs). The memory 306 stores data and/or instructions. The memory 306 may be one or more of a cache unit, a storage unit, an internal memory unit, or an external memory unit. As illustrated, the memory 306 includes a web application last version store 308, a current version of the web application 314, a delta file generator module 316, and the delta file 150.

The web application last version store 308 stores a set of client identifiers 310.1-n. Each client identifier 310.k identifies a computing device (for example, client computing device 110). Each client identifier 310.k can be, for example, a user identifier, an Internet Protocol (IP) address, an identifier of a specific client application (e.g., a specific web browser) executing on a specific client computing device (e.g., a user agent string), or one or more cookies. A client identifier 310.k may identify the associated client computing device (e.g., client computing device 110) and an associated client application (e.g., client application 208, which may be a web browser) executing on the client computing device.

Each client identifier 310.k is associated with a last version identifier 312.k. The last version identifier 312.k indicates the last version of the web application that the server 120 provided to the computing device identified by the associated client identifier 310.k. For example, if the client computing device 110 of FIG. 2 stores the last version of the web application 208, the client identifier 310.k for the client computing device 110 is coupled with the last version identifier 312.k for the last version of the web application 208. When a version of the web application stored on a computing device is updated via the server 120, the web application last version store 308 is updated to note the new version of the web application provided to the computing device.

The web application last version store 308 can be implemented using any data structure for storing associated data, for example, a hash table, an array, a matrix, a linked list, a stack, a queue, etc. As a result of storing the web application last version store 308, the server 120 may not need to send a query to a computing device (e.g., client computing device 110) to determine the version of the web application stored at the computing device.

The current version of the web application 314 stores the most current version of the web application, including all updates to the code of the web application. When a computing device accesses the web application for the first time in the lifetime of the computing device or after having its storage cleared, the server 120 may provide the current version of the web application 314 to the computing device. The current version of the web application 314 may be provided, by the server 120, to a computing device experiencing errors in executing the web application to fix the errors.

The delta file generator module 316 is configured to generate the delta file 150. The delta file 150 is provided to the client computing device 110 in response to the request by the client computing device 110 to access the web application. The delta file 150 can be generated in response to the request by the client computing device to access the web application. Alternatively, the delta file 150 can be pre-generated in advance of receiving the request to access the web application and provided to the client computing device 110 upon receipt of the request. Pre-generation of the delta file 150 may be especially effective if there are a small number (e.g., fewer than five) of versions of the web application or a small number of versions of the web application are likely to be stored at client computing devices. (E.g., most client computing devices that have previously accessed the application have one of fewer than five versions stored thereon.)

The delta file generator module 316 operates by determining, based on data stored in the web application last version store 308, the last version of the web application (e.g., last version of web application 210, which is identified by last version identifier 312.k) provided to a computing device having a client identifier 310.k associated with the client computing device 110, which is usually the client computing device 110 itself. The delta file generator module 316 determines difference(s) between the last version of the web application provided to the client computing device 110 and the current version of the web application 314. These differences are written into the delta file 150. As a result of generating the delta file 150, the client computing device 110 need not re-obtain the entire current version of the web application 314 from the server 120 every time the current version of the web application 314 is updated. Instead, the client computing device 110 may obtain only a smaller delta file 150 indicating the changes to the web application, reducing the amount of data that needs to be transmitted between the server 120 and the client computing device 110 via the network.

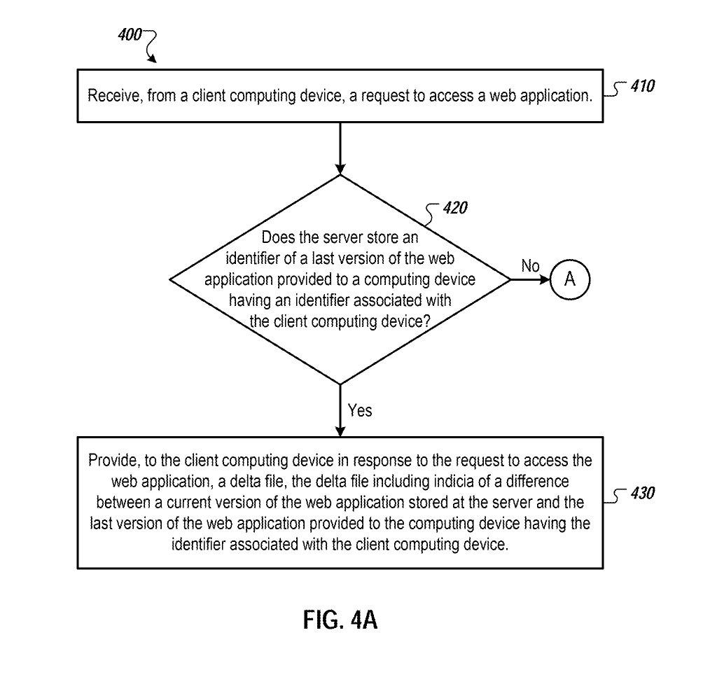

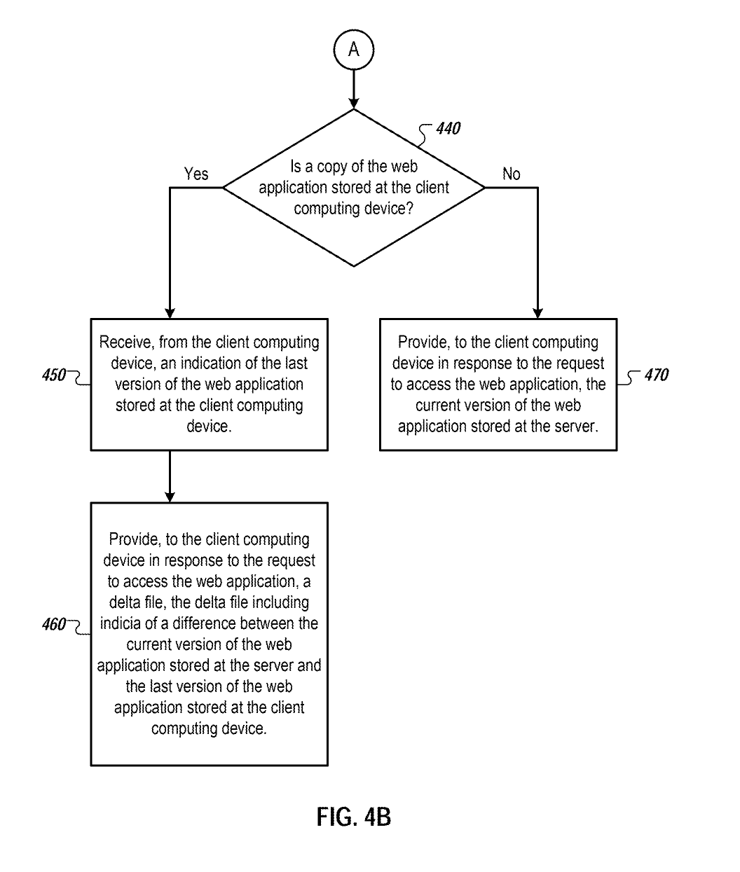

FIGS. 4A-4B illustrates an example process 400 by which a web application may be provided.

As shown in FIG. 4A, the process 400 begins at step 410 where a server (e.g., server 120) receives, from a client computing device (e.g., client computing device 110), a request (e.g., HTTP request 130) to access a web application (e.g., a web page). The client computing device can be running a client application (e.g., a web browser) that requests access to a web page by entering a URL or selecting a link. The request to access the web application may include the URL for the web application.

In step 420, the server determines whether the server stores locally at the server (e.g., in a memory of the server or in a data repository coupled with the server) an identifier (e.g., last version identifier 312.k) of a last version of the web application provided to a computing device having an identifier (e.g., client identifier 310.k) associated with the client computing device. The server makes the above determination based on data stored locally at the server without providing a query to the client computing device. If the server stores the identifier of the last version of the web application provided to the computing device having the identifier associated with the client computing device, the process 400 continues to step 430. Otherwise, the process 400 continues to step 440 of FIG. 4B.

In step 430, upon determining that the server stores the identifier of the last version of the web application provided to the computing device having the identifier associated with the client computing device, the server determines the last version of the web application provided to the client computing device based on the identifier of the last version. The server provides a delta file (e.g., delta file 150) to the client computing device. The delta file is provided in response to the request to access the web application. The delta file includes indicia of a difference between a current version of the web application stored locally at the server and the last version of the web application provided to the computing device having the identifier associated with the client computing device. The server transmits the delta file to the client computing device to provide for the client computing device recreating the current version of the web application at the client computing device based on the last version of the web application, as stored at the client computing device, and the delta file.

In some aspects, the server provides, to the client computing device, the full current version of the web application (e.g., so that the client computing device has the full current version in a case where the client computing device is unable to process the delta file or in a case where all or a portion of the local storage of the client computing device has been cleared). The delta file is provided to the client computing device before the full current version of the web application. The server may forego verifying receipt of the delta file by the client computing device. Alternatively, the server may verify receipt of the delta file by the client computing device after initiating providing, to the client computing device, the full current version of the web application. After step 430, the process 400 ends.

As shown in FIG. 4B, in step 440, upon determining that the server does not store the identifier of the last version of the web application provided to the computing device having the identifier associated with the client computing device, the server determines whether a copy of the web application is stored at client computing device. For example, the server may send a query to the client computing device inquiring whether the client computing device stores a copy of the web application and, if so, the version identifier of the copy of the web application stored at the client computing device.

According to some aspects, web application communication is initiated by the client computing device, which sends, to the server, the initial request for the web application. In response, the server determines (e.g., by reviewing a data structure in the memory of the server) that the server lacks information about the latest version of the web application stored at the client computing devices. The server queries that the client computing device notify the server which version, if any, of the web application is stored at the client computing device. Upon receiving the query, the client computing device responds with the requested information and provides, to the server another request for the web application. The server responds with the delta between the version of the web application stored at the client computing device and the latest version of the web application.

If the copy of the web application is stored at the client computing device, the process 400 continues to step 450. If the copy of the web application is not stored at the client computing device, the process 400 continues to step 470.

In step 450, upon determining that the copy of the web application is stored at the client computing device, the server receives, from the client computing device, an indication of the last version of the web application stored at the client computing device. For example, the server may receive, from the client computing device, the version identifier (e.g., version number) of the last version of the web application stored at the client computing device.

In step 460, the server provides, to the client computing device, in response to the request to access the web application, a delta file. The delta file includes indicia of a difference between the current version of the web application, stored at the server, and the last version of the web application, stored at the client computing device. The server transmits the delta file to the client computing device to provide for the client computing device recreating the current version of the web application at the client computing device based on the last version of the web application, as stored at the client computing device, and the delta file. After step 460, the process 400 ends.

In step 470, upon determining that the copy of the web application is not stored at the client computing device, the server provides, to the client computing device in response to the request to access the web application, the current version of the web application stored at the server. After step 470, the process 400 ends.

As shown in FIGS. 4A-4B and described above the steps 410-470 of the process 400 are implemented in numerical order and in series. However, the steps 410-470 may be implemented in any order. In some aspects, two or more of the steps 410-470 are implemented in parallel.

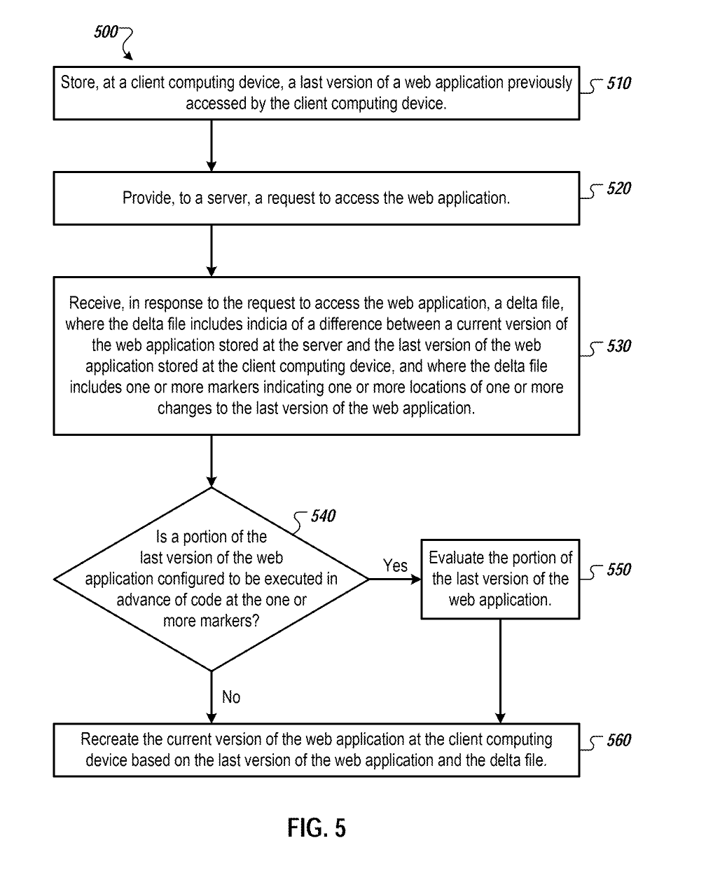

FIG. 5 illustrates an example process 500 by which a web application may be loaded.

The process 500 begins at step 510, where a client computing device (e.g., client computing device 110) stores a last version of a web application (e.g., last version of web application 210) previously accessed by the client computing device. The web application can be associated with a web page having a URL and can be accessed via a client application (e.g., a web browser).

In step 520, the client computing device provides, to a server (e.g., server 120), a request (e.g., HTTP request 130) to access the web application. For example, the client application can provide, to the server, a request to access a web application of a web page having a specified URL.

In step 530, the client computing device receives, in response to the request to access the web application, a delta file (e.g., delta file 150). The delta file includes indicia of a difference between a current version of the web application stored at the server and the last version of the web application stored at the client computing device. The delta file includes one or more markers indicating one or more locations of one or more changes to the last version of the web application. In some aspects, the delta file is embedded into boilerplate HTML or scripting language code (e.g., boilerplate information 140) associated with the web application.

In step 540, the client computing device determines whether a portion of the last version of the web application is configured to be executed in advance of code at the one or more markers. If the portion of the last version of the web application is configured to be executed in advance of the code at the one or more markers, the process 500 continues to step 550. Otherwise, the process 500 skips step 550 and continues to step 560.

In step 550, upon determining that the portion of the last version of the web application is configured to be executed in advance of the code at the one or more markers, the client computing device compiles the portion of the last version of the web application. The portion of the last version of the web application includes all or part of the code that is identical in both the last version of the web application stored at the client computing device and the current version of the web application stored at the server.

In step 560, the client computing device recreates the current version of the web application, for storing in a local memory (e.g., memory 206) of the client computing device, based on the last version of the web application and the delta file. Upon recreating the current version of the web application, the client computing device can compile and execute the current version of the web application. The recreated current version of the web application is stored in a local memory (e.g., memory 206) of the client computing device. In some aspects, steps 550 and 560 are carried out simultaneously or in parallel. After step 560, the process 500 ends.

As shown in FIG. 5 and described above the steps 510-560 of the process 500 are implemented in numerical order and in series. However, the steps 510-560 may be implemented in any order. In some aspects, two or more of the steps 510-560 are implemented in parallel.

Aspects of the subject technology involve storing identifier(s) of client computing device(s) or identifier(s) of client application(s) on a server. The storing of the identifier(s) is known to the user and described in contextual notices provide to the user in plain language, for example, when the user downloads or executes the client application or a web application. Furthermore, persistent reminders are provided in the user interface that the identifier(s) are being stored on the server. In some aspects, periodic reminders are provided to the user when the user logs into an application (e.g., every tenth login or every thirty days) or electronic messages (e.g., email) are provided to the user to remind him/her of the storing of the identifier(s). The user explicitly and affirmatively provides consent to having the identifier(s) stored and may easily withdraw or revoke such consent at any time via the user interface of the client computing device. Furthermore, the user may remove any identifier(s) associated with the user's computing device(s) stored on the server. In some aspects, a privacy dashboard may be provided via the client computing device that allows the user to determine which identifier(s) of his/her computing device(s) are stored on the server or to remove such identifier(s) from the server. Furthermore, all identifier(s) are encrypted when transmitted over a network to prevent unauthorized access to the identifier(s).

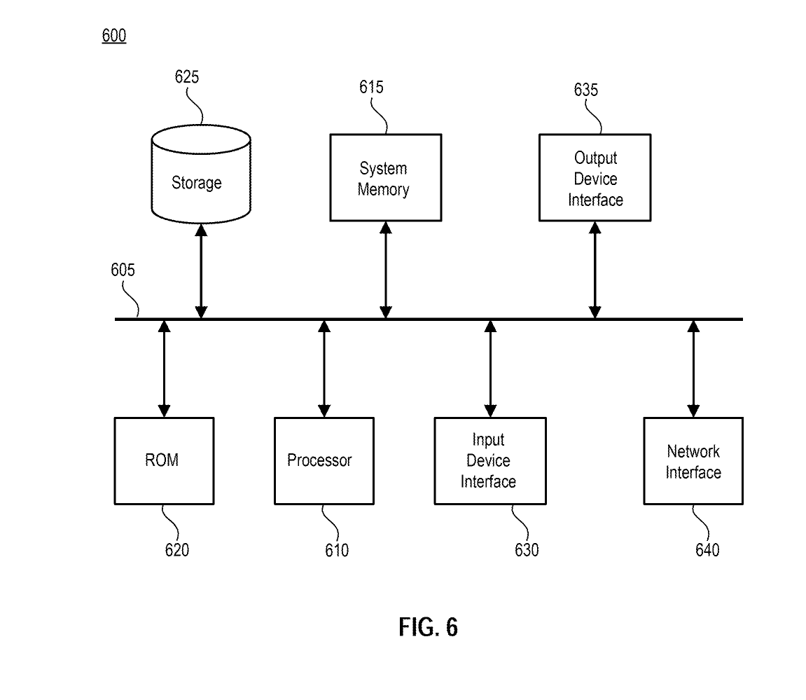

FIG. 6 conceptually illustrates an electronic system 600 with which some implementations of the subject technology are implemented. For example, one or more of the server 120 or the client computing device 110 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for delivering an update for a web application in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touch screen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A computer-implemented method for providing a web application, the method comprising:
receiving, from a client computing device, a request to access a web application;
determining, based on data stored locally at a server, a last version of the web application provided to a computing device having an identifier associated with the client computing device;
providing, to the client computing device in response to the request to access the web application, a delta file, the delta file comprising indicia of a difference between a current version of the web application stored at the server and the last version of the web application provided to the computing device having the identifier associated with the client computing device.

2. The method of claim 1, further comprising:
facilitating creation, at the client computing device, of a copy of the current version of the web application, the creation of the copy of the current version of the web application being based on the last version of the web application and the delta file.

3. The method of claim 1, further comprising:
providing, to the client computing device, the current version of the web application, wherein the delta file is provided to the client computing device before the current version of the web application.

4. The method of claim 3, further comprising:
verifying, at the server, receipt of the delta file by the client computing device.

5. The method of claim 4, wherein the verifying occurs after initiating providing, to the client computing device, the current version of the web application.

6. The method of claim 1, wherein determining the last version of the web application provided to the computing device comprises:
determining, based on a data structure mapping an identifier of the client computing device to a version of the web application previously provided to the client computing device by the server, the last version of the web application provided to the computing device, wherein the data structure is stored locally at the server.

7. The method of claim 1, wherein the request to access the web application comprises a uniform resource locator (URL) for the web application.

8. The method of claim 1, wherein the identifier identifies the client computing device and a specific web browser executing on the client computing device.

9. A computer-implemented method for loading a web application, the method comprising:
storing, at a client computing device, a last version of a web application previously accessed by the client computing device;
transmitting a request to access the web application;
receiving, in response to the request to access the web application, a delta file, wherein the delta file comprises indicia of a difference between a current version of the web application stored at a server and the last version of the web application stored at the client computing device, and wherein the delta file comprises one or more markers indicating one or more locations of one or more changes to the last version of the web application;
compiling a portion of the last version of the web application, wherein the portion of the last version of the web application is configured to be executed in advance of execution of code at the one or more markers;
recreating the current version of the web application at the client computing device based on the last version of the web application and the delta file.

10. The method of claim 9, wherein the web application is written in a scripting language and executes within a client application, wherein the client application is written in a programming language different from the scripting language, and wherein recreating the current version of the web application comprises executing code from the delta file, the code from the delta file being written in the programming language.

11. The method of claim 10, wherein the client application comprises a web browser.

12. The method of claim 10, wherein the programming language is C or C++, and wherein the scripting language is JavaScript.

13. The method of claim 10, wherein executing the code from the delta file comprises:
invoking, via the web application, the code from the delta file via an application programming interface (API) exposed by the client application.

14. The method of claim 9, wherein the delta file is embedded into boilerplate hypertext markup language (HTML) or scripting language code associated with the web application.

15. The method of claim 9, wherein compiling the portion of the last version of the web application and recreating the current version of the web application occur in parallel.

16. The method of claim 9, further comprising:
compiling and executing the recreated current version of the web application at the client computing device.

17. The method of claim 9, further comprising:
storing the recreated current version of the web application at the client computing device.

18. The method of claim 9, wherein the portion of the last version of the web application comprises code that is identical in both the last version of the web application stored at the client computing device and the current version of the web application stored at the server.

19. A system for providing a web application, the system comprising:
one or more processors; and
a memory comprising instructions which, when executed by the one or more processors, cause the one or more processors to implement a method, the method comprising:
receiving, from a client computing device, a request to access a web application;
determining, based on data stored locally in the memory and without providing a query to the client computing device, a last version of the web application provided to a computing device having an identifier associated with the client computing device;
providing, to the client computing device in response to the request to access the web application, a delta file, the delta file comprising indicia of a difference between a current version of the web application stored locally in the memory and the last version of the web application provided to the computing device having the identifier associated with the client computing device.

20. A non-transitory computer-readable medium for loading a web application, the computer-readable medium comprising instructions which, when executed by a computer, cause the computer to implement a method, the method comprising:
storing, in a local memory of the computer, a last version of a web application previously accessed by the computer;
transmitting a request to access the web application;
receiving, in response to the request to access the web application, a delta file, wherein the delta file comprises indicia of a difference between a current version of the web application stored at a server and the last version of the web application stored at the computer;
compiling a portion of the last version of the web application, wherein the portion of the last version of the web application comprises code that is identical in both the last version of the web application stored at the client computing device and the current version of the web application stored at the server;
recreating the current version of the web application at the computer based on the last version of the web application and the delta file; and
compiling and executing the recreated current version of the web application at the computer.
